(19) United States
(12) Patent Application Publication
(10) Pub. No.: US 2026/0245467 A1
(43) Pub. Date: Aug. 20, 2026

(54) PERSONALIZING A USER INTERFACE FOR TRAINING BY LEARNING AND MAPPING USER BEHAVIORS

(71) Applicant: INTERNATIONAL BUSINESS MACHINES CORPORATION, ARMONK, NY (US)

(72) Inventors: Susann Marie Keohane, Austin, TX (US); Johnny Shieh, Austin, TX (US); Jessica Murillo, Round Rock, TX (US)

(21) Appl. No.: 19/055,629

(22) Filed: Feb. 18, 2025

(51) Int. Cl. G09B 5/02; G06F 9/451; G06F 11/34

(52) U.S. Cl. CPC G09B 5/02; G06F 9/453; G06F 11/3438

(57) ABSTRACT

An approach is provided for personalizing a user interface for training by learning and mapping user behaviors. A mapping is received of actions taken by a user on a first system to respective instructional features describing how to perform the actions on a second system. The instructional features are provided by the second system, but not by the first system. Based on behaviors of the user on the first system, an action that the user will take on the second system is predicted. Based on the mapping of the actions, an instructional feature is identified as being mapped to the predicted action. The identified instructional feature is presented to the user on a user interface generated on the second system, so the user utilizing the user interface to perceive the identified instructional feature is trained on how to perform the predicted action on the second system.

### BACKGROUND

The present invention relates to user interface enhancements, and more particularly to developing a user interface that provides personalized training based on learned user behaviors.

### SUMMARY

In one embodiment, the present invention provides a computer-implemented method. The method includes receiving a mapping of actions taken by a user on a first system to respective instructional features describing how to perform the actions on a second system. The instructional features are provided by the second system, but not by the first system. The method further includes receiving a mapping of actions taken by a user on a first system to respective instructional features describing how to perform the actions on a second system. The instructional features are provided by the second system, but not by the first system. The method further includes, based on behaviors of the user on the first system, predicting an action that the user will take on the second system. The predicted action is included in the mapped actions. The method further includes, based on the mapping of the actions, identifying an instructional feature as being mapped to the predicted action. The method further includes generating a user interface on the second system. The method further includes presenting the identified instructional feature to the user on the user interface, so the user utilizing the user interface to perceive the identified instructional feature is trained on how to perform the predicted action on the second system.

A computer system and a computer program product corresponding to the above-summarized computer-implemented method are also described herein.

### BRIEF DESCRIPTION OF THE DRAWINGS

FIG. 1 is a block diagram of a system for personalizing a user interface for training by learning and mapping user behaviors, in accordance with embodiments of the present invention.

FIG. 2 is a block diagram of a first set of modules included in code included in a first system that includes the components of the system of FIG. 1, in accordance with embodiments of the present invention.

FIG. 3 is a block diagram of a second set of modules included in code included in a second system that includes the components of the system of FIG. 1, in accordance with embodiments of the present invention.

FIG. 4 is a flowchart of a process of personalizing a user interface for training by learning and mapping user behaviors, where operations of the flowchart are performed by modules in FIG. 2 and FIG. 3, in accordance with embodiments of the present invention.

### DETAILED DESCRIPTION

### Overview

For most people, there is a massive barrier to adopting or upgrading to a new technology, new technological features, or a new system. Different technologies and systems require different ways to perform the same or similar functions. Conventional approaches to assisting a user who is adopting or upgrading as described above includes utilizing user manuals or online videos for instruction or troubleshooting. Watching training videos or researching technologies online are current approaches to find information about transitioning from one technology to another. Using the conventional approaches to find the precise information the user seeks, however, still takes an amount of time that is unacceptable to many users. Few users have the time or the inclination to review user manuals or perform the online research to find an appropriate and effective online training video. The users who do not have sufficient time or motivation to find an appropriate and effective online training video fail to quickly and efficiently learn how to perform actions on a new technology, even though the users are familiar with performing the same actions on a currently utilized technology.

Embodiments of the present invention address the aforementioned unique challenges by providing an enhanced user interface on a new technology, so that the enhanced user interface provides easily accessible, customized tutorials and/or training that teaches a user (i) how to perform actions on the new technology that match the actions the user already knows how to perform on a currently utilized technology and/or (ii) how to achieve results on the new technology that match results the user already knows how to achieve on a currently utilized technology.

In one embodiment, a system for personalizing a user interface for training by learning and mapping user behaviors, as disclosed herein, (i) captures and learns user behavior relative to the user performing actions on a first system that the user currently utilizes, (ii) maps sequences of atomic steps on the first system to equivalent sequences on a second system, (iii) maps the most common user actions on the first system to instructional features (e.g., prompts and tutorials) on the second system, (iv) predict which action the user will take based on the captured and learned user behavior, (v) identify an instructional feature as being mapped to the predicted action, (vi) generate a user interface on the second system, and (vii) present the identified instructional feature to the user on the user interface on the second system, so the user utilizing the user interface to perceive the identified instructional feature is trained on how to perform the predicted action on the second system. As used herein, the words and phrases “system,” “first system,” and “second system” (without any further modifiers) each refer to a technology, a computer system, a computing device, or a software application executing on a computer system. As used herein, the words “first” and “second” in “first system” and “second system” are modifiers that simply distinguish between two different systems and do not indicate a relative order between the two systems or between the first or second system and any other system.

As users transition by switching or changing a technological system, software, or modalities they use, the system for personalizing a user interface for training by learning and mapping user behaviors, as disclosed herein, provides an improved way for the users to access information needed so that the users experience a smoother and faster transition, which promotes an improved user experience and greater efficiency.

### Computing Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, computer-readable storage media (also called “mediums”) collectively included in a set of one, or more, storage devices, and that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

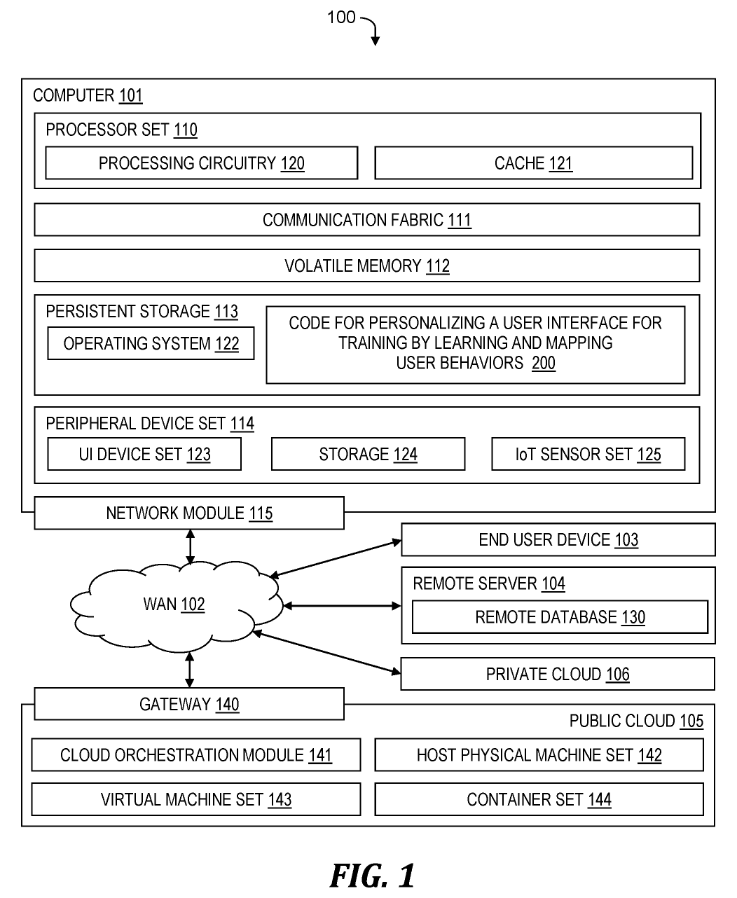

FIG. 1 is a block diagram of a system for personalizing a user interface for training by learning and mapping user behaviors, in accordance with embodiments of the present invention. Computing environment 100 contains an example of an environment for the execution of at least some of the computer code involved in performing the inventive methods, such as code 200 for resolving a programmatic error at runtime using an internal request retry. The aforementioned computer code is also referred to herein as computer-readable code, computer-readable program code, and machine readable code. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

### System and Process for Personalizing a user Interface for Training by Learning and Mapping user Behaviors

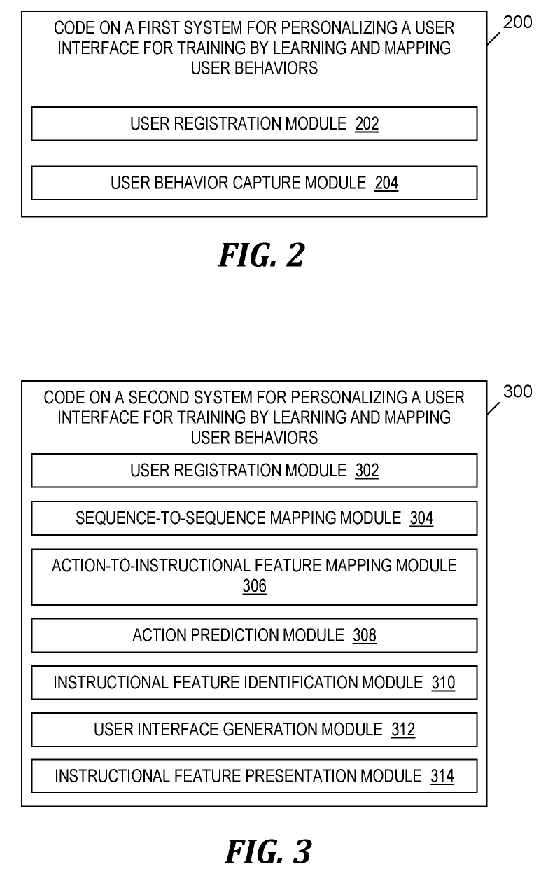

FIG. 2 is a block diagram of a first set of modules included in code included in a first system that includes the components of the system of FIG. 1, in accordance with embodiments of the present invention. Code 200 includes a user registration module 202 and a user behavior capture module 204.

User registration module 202 is configured to register a user on a first system, where the registration permits the first system to capture behaviors of the user on the first system and identifies a second system as the system the user wants to use to (i) perform actions equivalent to actions the user has performed on the first system and/or (ii) achieve results equivalent to results the user has previously achieved by using the first system. The registration of the user also causes the system for personalizing a user interface for training by learning and mapping user behaviors to be enacted on the first system. The first system is also referred to herein as the “old” system, the system the user is currently utilizing, or the system the user has used previously. The second system is also referred to herein as the “new” system or the system the user wants to use. The user may opt-out of allowing the first system to capture the behaviors of the user.

User behavior capture module 204 is configured to capture behaviors of the user on the first system. In one embodiment, user behavior capture module 204 performs a heuristic analysis on actions of the user on the old system and determines which actions are most common. The heuristic analysis includes capturing an identification, a timing, a frequency, and a recurrence schedule for each feature or function the user utilizes on the first system (i.e., capturing the what, when, how often, and the schedule for recurrent usage for each feature or function, such as which days of the week or which days of the month).

In one embodiment, user behavior capture module 204 captures a sequence of steps as defining a behavior of the user. The sequence of steps is also known as an n-gram of steps. For example, the producer of a product (which is the first system) defines atomic steps for the product. For digital products, examples of atomic steps can be: Press function key N, Type a character, Press enter, Click on button N, Drag and drop object A to position B, etc. For a physical object (e.g., a car) which is the product, examples of atomic steps can be: Insert the key into the ignition, Turn the key to start the engine, Turn the key to accessories position, Press button N on the dashboard, Pop the trunk open, etc.

There are cases in which different sequences of steps lead to exactly the same result. Given that there are two steps: A and B, if the order of these two steps is irrelevant to the result, then A B (i.e., A followed by B) is the same as B A (i.e., B followed by A). The number of sequences is reduced by transforming all incoming actual sequences into a canonical order, so whenever B A is included in an incoming sequence, user behavior capture module 204 changes the B A in the sequence to A B. In this situation with A B being the same as B A, A and B is a commutative pair (i.e., A and B commute with each other). Typically, there is a significant number of commutative pairs in incoming sequences, which means that a significant number of changes are made for all incoming sequences, where the changes are in the form of the B A to A B change described above. These changes result in the number of unique “interesting” or “semantic” distinct sequences being significantly reduced (i.e., the number of distinct sequences resulting from the aforementioned changes is less than the number of sequences in the initial incoming sequences). For digital products, the producer of the product defines which steps commute with each other.

In one embodiment, user behavior capture module 204 captures user behaviors from the results of a macro capture capability of the product (i.e., the first system). The user activates an event capture feature provided by the macro capture capability, the event capture feature begins recording steps performed on the product, and the user executes a sequence of steps during the recording of the steps. The event capture feature saves the recorded sequence of steps in a sequence library, where the saved recorded sequence can have a user-defined name.

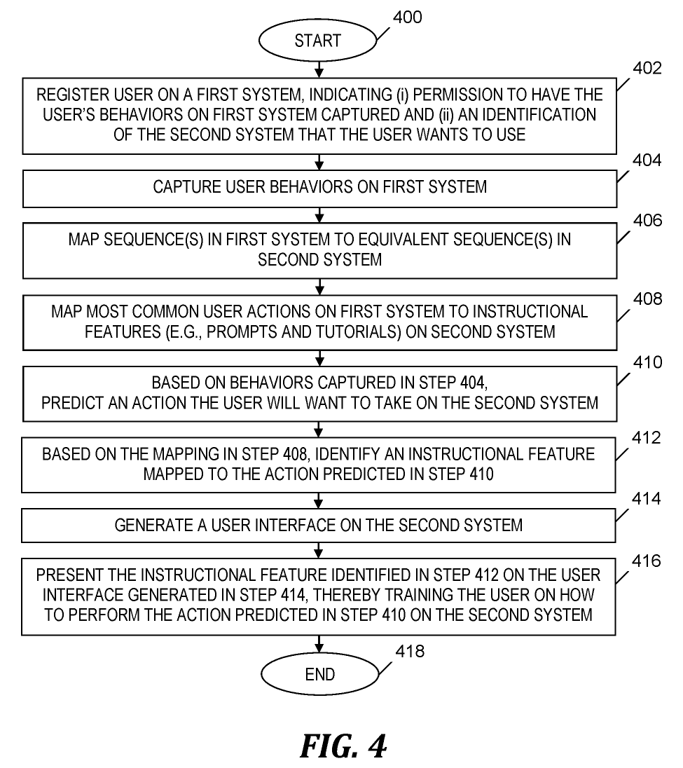

The functionality of the modules included in code 200 is described in more detail in the discussion presented below relative to FIG. 4.

FIG. 3 is a block diagram of a second set of modules included in code included in a second system that includes the components of the system of FIG. 1, in accordance with embodiments of the present invention. Code 300 includes a user registration module 302, a sequence-to-sequence mapping module 304, an action-to-instructional feature mapping module 306, an action prediction module 308, an instructional feature identification module 310, a user interface generation module 312, and an instructional feature presentation module 314.

User registration module 302 is configured to register the user on the second system, so that the system for personalizing a user interface for training by learning and mapping user behaviors is enacted on the second system.

Sequence-to-sequence mapping module 304 is configured to map a sequence on the first system to an equivalent sequence on the second system by (i) searching for a match by sequence name and (ii) employing a search engine functionality that searches for sequences based on an ordered list of the atomic steps of a sequence. Because of the aforementioned commutative pairs present in the incoming sequences, the number of sequence variations is significantly reduced, so the search is performed on the canonical order. Using a search for a match by sequence name will be successful only in some cases because different users use different terms to describe the same sequences.

In one embodiment, the mapping performed by sequence-to-sequence mapping module 304 includes receiving a producer-created mapping file that maps sequences in the first system to sequences in the second system. For example, the producer of new product Q manually creates a mapping file that maps sequences in product P to sequences in product Q. For example, the mapping file includes a mapping of sequence P.3 to sequence Q.7, sequence P.4 to sequence Q.9, etc. The producer of Q can also create mapping files for multiple products R, S, and T, which are viewed as competitors to Q.

In one embodiment, the producer of product Q does not provide a mapping file or does not provide a mapping file for a particular product R. In these situations, users provide their own mapping files. For example, in an online discussion forum, a user posts the question “How do I do X.” Rather than only text, the post in the forum includes a sequence of atomic steps. When other users provide responses to the question in the forum, the responses also include sequences of atomic steps. A set of atomic steps in a response is mapped to the set of atomic steps in the question, thereby making an entry in the user-provided mapping file.

In one embodiment, the user-provided mapping file described above is created in addition to the mapping file created by the producer of the product.

In one embodiment, sequence-to-sequence mapping module 304 (i) trains a recurrent neural network (RNN) with equivalent pairs that match sequences of atomic steps in the first system to sequences of atomic steps in the second system so that the RNN can translate one sequence to another sequence in a manner similar to an automatic translation feature of an RNN that translates between natural languages; and (ii) translates a first sequence of atomic steps in the first system to a second sequence of atomic steps in the second system by using the trained RNN. The mapping of the first sequence to the second sequence by sequence-to-sequence mapping module 304 is based on the translation by the RNN of the first sequence to the second sequence. In one embodiment, using the RNN for sequence translation also handles variations in sequences.

Action-to-instructional feature mapping module 306 is configured to map the most common actions of the user on the first system to instructional features provided on the second system. The instructional features include, for example, prompts and tutorials.

Action prediction module 308 is configured to predict which action the user will take on the second system based on what action the user typically takes in the first system based on the behaviors that were captured by user behavior capture module 204 that were performed under circumstances on the first system that match the current circumstances of the user on the second system.

In one embodiment, action prediction module 308 determines which action the user typically takes upon opening the first system, which results in the second system providing a prompt and/or tutorial for the same action on the second system. For example, User B is transitioning from using Software application ABC to Software application DEF. Action prediction module 308 determines that when signing onto Software application ABC, the first action User B takes is looking at User B’s calendar for the current week and accepting any outstanding invitations that arrived while User B was signed out. When User B opens Software application DEF for the first time, the system disclosed herein provides an enhanced user interface in Software application DEF that includes prompts and tutorials that train User B in opening the calendar and accepting calendar invites in Software application DEF.

In one embodiment, action prediction module 308 predicts an action the user will take on the second system and provides a relevant tutorial on the second system for training the user on how to perform the predicted action based on the user’s behaviors captured by user behavior capture module 204 and/or the user’s predicted behavior, which can be based on the following examples:

time of day (e.g., the user usually performs Action Z as their first action in the morning)

previous action (e.g., most users perform Action X after completing Action Y)

frequency of action (e.g., User B creates significantly more meeting invites than a typical user)

typical sequencing of action for a given user (e.g., User B usually performs Action X after completing Action Y)

pauses in action (e.g., if a user pauses for more than N minutes, the user may be lost and not know what to do next in the system)

speed of action (e.g., if a user’s speed of action is less than predefined Speed S, then the user may be struggling with determining what actions to take in the system)

repetition of action (e.g., if a user creates several similar calendar invites in a row, the user may want to create a recurring meeting)

Instructional feature identification module 310 is configured to identify an instructional feature (e.g., prompt or tutorial) on the second system that is mapped to the action predicted by action prediction module 308.

User interface generation module 312 is configured to generate an enhanced user interface on the second system.

Instructional feature presentation module 314 is configured to present the instructional feature identified by instructional feature identification module 310 on the user interface generated by user interface generation module 312, so that the user who utilizes the user interface to perceive the instructional feature is trained on how to perform the action on the second system, where the action is predicted by action prediction module 308.

The functionality of the modules included in code 300 is described in more detail in the discussion presented below relative to FIG. 4.

FIG. 4 is a flowchart of a process of personalizing a user interface for training by learning and mapping user behaviors, where operations of the flowchart are performed by modules in FIG. 2 and FIG. 3, in accordance with embodiments of the present invention. The process of FIG. 4 begins at a start node 400. In step 402, user registration module 202 registers a user on a first system, indicating (i) permission to have the user’s behaviors on the first system captured and (ii) an identification of a second system that the user would like to use.

Although not shown in FIG. 4, user registration module 302 registers the user on the second system so that the system for personalizing a user interface for training by learning and mapping user behaviors, as disclosed herein, is enacted on the second system.

In step 404, user behavior capture module 204 captures user behaviors on the first system.

In step 406, sequence-to-sequence mapping module 304 maps sequence(s) in the first system to equivalent sequence(s) in the second system.

In step 408, after determining what user actions are most common on the first system, action-to-instructional feature mapping module 306 maps the most common user actions on the first system to instructional features (e.g., prompts and tutorials) on the second system.

In step 410, based on behaviors captured in step 404, action prediction module 308 predicts an action the user wants to take on the second system.

In step 412, based on the mapping in step 408, instructional feature identification module 310 identifies an instructional feature mapped to the action predicted in step 410.

In step 414, user interface generation module 312 generates an enhanced user interface on the second system.

In step 416, instructional feature presentation module 314 presents the instructional feature identified in step 412 on the user interface generated in step 414, so that the user utilizes the user interface and perceives the identified instructional feature via the user interface, thereby training the user on how to perform the predicted action on the second system.

In one embodiment, instructional feature presentation module 314 offers the user an option to select a new modality (e.g., voice command) for presenting the instructional feature.

Following step 416, the process of FIG. 4 ends at an end node 418.

In one embodiment, a cohort analysis module included in code 300, but not shown in FIG. 3, (i) determines that multiple users belong to a cohort based on the multiple users having performed shared (i.e., the same) actions on the first system; (ii) monitors and collects user data about the multiple users in the cohort to determine learnings about the multiple users, where the user data specifies how effective different instructional features are for training the multiple users to perform a particular action on the second system; (iii) subsequent to the monitoring and the collecting of the user data about the multiple users, determines that a new user not included in the multiple users also belongs to the cohort and in response, transfers the learnings about the multiple users to the new user; and (iv) based on the user data, the transferred learning, and the new user belonging to the cohort, selects a particular instructional feature from the different instructional features so that the new user utilizing the user interface on the second system to perceive the selected particular instructional feature is effectively trained on how to perform the particular action on the second system.

The descriptions of the various embodiments of the present invention have been presented herein for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
receiving a mapping of actions taken by a user on a first system to respective instructional features describing how to perform the actions on a second system, wherein the instructional features are provided by the second system but not by the first system;
based on behaviors of the user on the first system, predicting an action that the user will take on the second system, the predicted action being included in the mapped actions;
based on the mapping of the actions, identifying an instructional feature as being mapped to the predicted action;
generating a user interface on the second system; and
presenting the identified instructional feature to the user on the user interface, so the user utilizing the user interface to perceive the identified instructional feature is trained on how to perform the predicted action on the second system.

2. The method of claim 1, further comprising:
mapping a sequence of atomic steps to perform the action in the first system to a sequence of atomic steps to perform the action in the second system by using a search engine functionality that searches for sequences, wherein the search engine functionality includes providing a search for an equivalent sequence included in a plurality of sequences based on an ordered list of atomic steps of a given sequence.

3. The method of claim 2, further comprising:
transforming initial incoming sequences of atomic steps to respective sequences having atomic steps in a canonical order, so that a count of the respective sequences that are distinct from each other based on the canonical order is less than a count of the initial incoming sequences, wherein the plurality of sequences which is searched by the search engine functionality includes the respective sequences that are distinct based on the canonical order.

4. The method of claim 1, wherein the receiving the mapping of the actions includes receiving a mapping file that maps sequences of atomic actions in the first system to sequences of atomic actions in the second system, wherein the mapping file is generated by a producer of the second system.

5. The method of claim 1, wherein the receiving the mapping of the actions includes receiving a mapping file that maps sequences of atomic actions in the first system to sequences of atomic actions in the second system, wherein entries in the mapping file are generated based on responses about the actions, the responses being provided to users on an online discussion site.

6. The method of claim 1, further comprising:
training a recurrent neural network (RNN) with equivalent pairs that match sequences of atomic steps in the first system to sequences of atomic steps in the second system; and
translating a first sequence of atomic steps in the first system to a second sequence of atomic steps in the second system by using the RNN, wherein the mapping of actions includes the first sequence translated to the second sequence.

7. The method of claim 1, further comprising:
determining that multiple users belong to a cohort based on the multiple users having performed shared actions on the first system;
monitoring and collecting user data about the multiple users in the cohort to determine learnings about the multiple users, wherein the user data specifies how effective different instructional features are for training the multiple users to perform a particular action on the second system;
subsequent to the monitoring and the collecting the user data about the multiple users, determining that a new user not included in the multiple users also belongs to the cohort and in response, transferring the learnings about the multiple users to the new user; and
based on the user data and further based on the new user belonging to the cohort and the transferred learnings, selecting a particular instructional feature from the different instructional features so that the new user utilizing the user interface on the second system to perceive the selected particular instructional feature is effectively trained on how to perform the particular action on the second system.

8. The method of claim 1, further comprising:
registering the user on the first system to permit the first system to capture the behaviors of the user on the first system and identify the second system as being a system the user wants to use.

9. The method of claim 1, further comprising:
capturing the behaviors of the user on the first system by performing a heuristic analysis on the actions taken by the user on the first system, wherein the performing the heuristic analysis includes capturing an identification, a timing, a frequency, and a recurrence schedule of a given feature or function utilized by the user in a given behavior, and wherein the predicting the action is further based on the captured behaviors.

10. The method of claim 1, further comprising:
capturing the behaviors of the user on the first system as sequences of atomic steps defined by a producer of the first system, wherein the predicting the action is further based on the captured behaviors.

11. The method of claim 1, further comprising:
capturing the behaviors of the user on the first system by (i) activating an event capture feature on the first system; (ii) initiating a recording of steps performed on the first system by using the activated event capture feature; (iii) during the recording, executing a sequence of steps performed on the first system by the user; and (iv) saving the sequence of steps in a sequence library, wherein the predicting the action is further based on the captured behaviors.

12. A computer system comprising:
a processor set;
one or more computer-readable storage media; and
program instructions stored on the one or more computer-readable storage media to cause the processor set to perform operations comprising:
receiving a mapping of actions taken by a user on a first system to respective instructional features describing how to perform the actions on a second system, wherein the instructional features are provided by the second system but not by the first system;
based on behaviors of the user on the first system, predicting an action that the user will take on the second system, the predicted action being included in the mapped actions;
based on the mapping of the actions, identifying an instructional feature as being mapped to the predicted action;
generating a user interface on the second system; and
presenting the identified instructional feature to the user on the user interface, so the user utilizing the user interface to perceive the identified instructional feature is trained on how to perform the predicted action on the second system.

13. The computer system of claim 12, wherein the operations further comprise:
mapping a sequence of atomic steps to perform the action in the first system to a sequence of atomic steps to perform the action in the second system by using a search engine functionality that searches for sequences, wherein the search engine functionality includes providing a search for an equivalent sequence included in a plurality of sequences based on an ordered list of atomic steps of a given sequence.

14. The computer system of claim 13, wherein the operations further comprise:
transforming initial incoming sequences of atomic steps to respective sequences having atomic steps in a canonical order, so that a count of the respective sequences that are distinct from each other based on the canonical order is less than a count of the initial incoming sequences, wherein the plurality of sequences which is searched by the search engine functionality includes the respective sequences that are distinct based on the canonical order.

15. The computer system of claim 12, wherein the receiving the mapping of the actions includes receiving a mapping file that maps sequences of atomic actions in the first system to sequences of atomic actions in the second system, wherein the mapping file is generated by a producer of the second system.

16. The computer system of claim 12, wherein the receiving the mapping of the actions includes receiving a mapping file that maps sequences of atomic actions in the first system to sequences of atomic actions in the second system, wherein entries in the mapping file are generated based on responses about the actions, the responses being provided to users on an online discussion site.

17. The computer system of claim 12, wherein the operations further comprise:
training a recurrent neural network (RNN) with equivalent pairs that match sequences of atomic steps in the first system to sequences of atomic steps in the second system; and
translating a first sequence of atomic steps in the first system to a second sequence of atomic steps in the second system by using the RNN, wherein the mapping of actions includes the first sequence translated to the second sequence.

18. A computer program product comprising:
one or more computer-readable storage media; and
program instructions stored on the one or more computer-readable storage media to perform operations comprising:
receiving a mapping of actions taken by a user on a first system to respective instructional features describing how to perform the actions on a second system, wherein the instructional features are provided by the second system but not by the first system;
based on behaviors of the user on the first system, predicting an action that the user will take on the second system, the predicted action being included in the mapped actions;
based on the mapping of the actions, identifying an instructional feature as being mapped to the predicted action;
generating a user interface on the second system; and
presenting the identified instructional feature to the user on the user interface, so the user utilizing the user interface to perceive the identified instructional feature is trained on how to perform the predicted action on the second system.

19. The computer program product of claim 18, wherein the operations further comprise:
mapping a sequence of atomic steps to perform the action in the first system to a sequence of atomic steps to perform the action in the second system by using a search engine functionality that searches for sequences, wherein the search engine functionality includes providing a search for an equivalent sequence included in a plurality of sequences based on an ordered list of atomic steps of a given sequence.

20. The computer program product of claim 19, wherein the operations further comprise:
transforming initial incoming sequences of atomic steps to respective sequences having atomic steps in a canonical order, so that a count of the respective sequences that are distinct from each other based on the canonical order is less than a count of the initial incoming sequences, wherein the plurality of sequences which is searched by the search engine functionality includes the respective sequences that are distinct based on the canonical order.
